(19) United States
(12) Patent Application Publication
(10) Pub. No.: US 2026/0338907 A1
(43) Pub. Date: Oct. 29, 2026

(54) VEHICLES, SYSTEMS, AND CONTROL LOGIC FOR DYNAMIC MICRO-TRIANGULATION OF VEHICLES USING REFERENCE MARKS

(71) Applicant: GM Global Technology Operations LLC, Detroit, MI (US)

(72) Inventors: Suresh Munagapati, Cumming, GA (US); Umer Khalid, Farmington Hills, MI (US); Russell A. Patenaude, Macomb Township, MI (US)

(73) Assignee: GM Global Technology Operations LLC, Detroit, MI (US)

(21) Appl. No.: 19/192,230

(22) Filed: Apr. 28, 2025

(51) Int. Cl. G01S 5/00; G01S 19/45

(52) U.S. Cl. CPC G01S 5/00; G01S 19/45

(57) ABSTRACT

Presented herein are vehicle systems with attendant control logic enabling dynamic micro-triangulation of vehicles coordinates using environmental markers, methods for making and methods for operating such vehicle control systems, and motor vehicles equipped with such control systems. A representative method includes flagging an initial tag located at an initial location at an initial time. The method includes discerning an initial relative vector between the initial tag and a vehicle at the initial time. The method includes discerning a subsequent relative vector between the initial tag and the vehicle at a subsequent location at a subsequent time. The method includes determining a subsequent vehicle coordinate of the vehicle based on the initial relative vector and the subsequent relative vector.

### FIELD OF INVENTION

The present disclosure relates generally to spatial triangulation of motor vehicles. More specifically, aspects of this disclosure relate to systems, methods, and devices for dynamically triangulating motor vehicles based on surreptitious, clandestine, camouflaged, or mundane reference markers.

### BACKGROUND

For centuries, explorers have relied on a variety of navigation methods to guide their journeys through diverse and often uncharted terrain. Early expeditions, whether by foot, horse, or early motor vehicles, depended on traditional techniques such as paper maps, magnetic compasses, and recognizable landmarks. While these methods were effective to an extent, they often proved imprecise and cumbersome—especially during fast-paced travel or in unfamiliar, rugged environments. As exploration expanded throughout the 20th century, particularly with the advent of off-road and all-terrain vehicles, the need for more sophisticated navigation systems became apparent. Despite improvements in mapping and communication tools, explorers continued to face significant challenges when navigating dense forests, remote mountain ranges, or urban jungles—where visibility and reference points were limited.

The arrival of the Global Positioning System (GPS) in the late 20th century marked a transformative leap in how explorers navigated the world. GPS enabled real-time, highly accurate positioning, allowing travelers and researchers to confidently traverse vast and unfamiliar landscapes. When integrated into onboard systems, GPS greatly enhanced the planning and tracking of routes, improving both safety and efficiency during long expeditions. Whether crossing desert plains, navigating icy tundras, or exploring remote island chains, GPS empowered modern adventurers to adapt quickly to changing conditions and coordinate movements with precision. This technology has since become indispensable in the field of exploration, increasing situational awareness and significantly reducing the risks of disorientation or getting lost in complex environments.

Despite its widespread use, GPS is not always reliable in the most remote or challenging environments. Explorers may venture into regions where satellite signals are weak or completely blocked—such as deep valleys, dense jungles, underground cave systems, politically contested zones, or areas with extensive tree cover or urban canyons. In addition, electronic interference or natural obstructions can disrupt GPS functionality. These limitations highlight the growing need for alternative navigation technologies capable of delivering accurate, dependable performance even when GPS signals fail. Modern exploration—whether scientific, archaeological, reconnaissance-based, or adventure-driven—often demands a higher level of precision than traditional methods can offer, particularly when navigating complex terrain or coordinating with autonomous equipment such as drones or robotic survey vehicles. Digital navigation tools have become essential not only for determining current location but also for planning routes, collecting geospatial data, and executing coordinated movements across challenging landscapes.

As the nature of exploration evolves and pushes further into uncharted or extreme environments, the demand for advanced navigation systems that work independently of GPS grows increasingly urgent. The ability to provide accurate, reliable positioning data in GPS-denied zones is critical for the safety and success of modern expeditions. Developing navigation technologies that offer high digital precision—regardless of external signal availability—is key to ensuring smooth, efficient travel and the successful completion of missions. Whether leading a team through a remote desert, coordinating autonomous equipment on a glacier, or mapping undiscovered cave networks, today's explorers rely on cutting-edge tools that enhance navigation capabilities and open up new frontiers for discovery.

### SUMMARY

Presented herein are vehicle systems with attendant control logic enabling dynamic micro-triangulation of vehicles coordinates using environmental markers, methods for making and methods for operating such vehicle control systems, and motor vehicles equipped with such control systems.

By way of example, there is presented a system and method for a vehicle tracking one or more physical markers in an environment, in order to triangulate a current or subsequent position based on an earlier or initial position. The method may enable the vehicle to physically produce the markers in the environment, in order to facilitate the triangulation. The method may enable the vehicle to initially or ultimately determine its geographic coordinates via a Global Positioning System, and determine positions of the vehicle between the initial or ultimate determination based on the triangulated movement coordinates of the vehicle. The method may enable utilizing multiple heterogenous methods of determining relative movement of the vehicle in the environment, including wheel rotation, compass readings, angular motion, and the difference between initial and subsequent vectors directed at one or more physical markers in the environment.

Attendant benefits for at least some of the disclosed concepts include determining precise positioning data of a vehicle without requiring network connections or emitted signals during the transit of the vehicle. Disclosed protocols also allow for providing additional physical markers to aid subsequent vehicles—vehicles which may have precise data regarding the physical markers, or merely generic information regarding the structure but not necessarily location of such physical markers. Additional attendant benefits include a reduced or eliminated reliance on Global Positioning Systems for determining vehicle coordinates, which is a material benefit in environments which have intermittent or no access to Global Positioning Systems.

Aspects of this disclosure are directed to vehicle control systems, system control logic, and memory-stored instructions for micro-triangulation of vehicles using perceptible environmental tags. In an example, a method is presented for determining a position of a vehicle having a coordinating controller or module or network of controllers/modules (collectively “controller” or “vehicle controller”) and an on-vehicle network of sensing devices (e.g., radar transceiver(s), LiDAR scanner(s), high-definition video camera(s), microphone(s), short-range radio transceiver(s), magnetometers, etc.). This exemplary method includes, in any order and in any combination with any of the above and below disclosed options and features: flagging an initial tag located at an initial location at an initial time; discerning an initial relative vector between the initial tag and a vehicle at the initial time; discerning a subsequent relative vector between the initial tag and the vehicle at a subsequent location at a subsequent time; and based on the initial relative vector and the subsequent relative vector, determine a subsequent vehicle coordinate of the vehicle.

Aspects of this disclosure are also directed to computer-readable media (CRM) for enabling external control of vehicles using visible and audible cues. In an example, a non-transitory CRM stores instructions that are executable by one or more processors of a vehicle controller. When executed by the processor(s), these instructions cause the controller to perform operations, including: flagging an initial tag located at an initial location at an initial time; discerning an initial relative vector between the initial tag and a vehicle at the initial time; discerning a subsequent relative vector between the initial tag and the vehicle at a subsequent location at a subsequent time; and based on the initial relative vector and the subsequent relative vector, determining a subsequent vehicle coordinate of the vehicle.

Additional aspects of this disclosure are directed to motor vehicles with intelligent control systems that provision external vehicle control using signs, gestures, verbal commands, etc. As used herein, the terms “vehicle”, “wheeled vehicle”, and “motor vehicle” may be used interchangeably and synonymously to include any relevant vehicle platform, such as passenger vehicles (ICE, HEV, FEV, fuel cell, fully or partially autonomous, etc.), commercial vehicles, industrial vehicles, tracked vehicles, off-road and all-terrain vehicles, motorcycles, farm equipment, watercraft, aircraft, drones, Vertical Take-off and Landing craft, etc., or any manufactured physical object capable of being motivated between two points in space. In an example, a motor vehicle includes a vehicle body with a passenger compartment, multiple road wheels mounted to the vehicle body (e.g., via corner modules coupled to a unibody or body-on-frame chassis), and other standard original equipment. A vehicle powertrain with a prime mover, such as an internal combustion engine (ICE) assembly and/or an electric traction motor, drives one or more of the road wheels to propel the vehicle. A network of sensing devices is distributed across the vehicle body and communicates sensor data to a resident or remote vehicle controller to help govern operation of the motor vehicle.

The above summary does not represent every embodiment or every aspect of the present disclosure. Rather, the foregoing summary merely provides a synopsis of some of the novel concepts and features set forth herein. The above features and advantages, and other features and attendant advantages of this disclosure, will be readily apparent from the following Detailed Description of illustrated examples and exemplary modes for carrying out the disclosure when taken in connection with the accompanying drawings and appended claims. Moreover, this disclosure expressly includes any and all combinations and subcombinations of the elements and features presented above and below.

### BRIEF DESCRIPTION OF THE DRAWINGS

FIG. 1 is a side-view illustration of an exemplary motor vehicle in an environment with multiple physical landmarks, as well as several exemplary deployable markers and marking tools by which tags can be made and flagged.

FIG. 2 is an illustration of a map and an exemplary motor vehicle traversing the mapped area over a series of time intervals, and repeatedly determining its relative position.

FIG. 3 is a flowchart illustrating an exemplary vehicle micro-triangulation algorithm, which may correspond to memory-stored instructions that are executable by a resident or remote controller, control-logic circuit, programmable control unit, or other integrated circuit (IC) device or network of devices in accord with an embodiment of the disclosed concepts.

FIG. 4 is a flowchart illustrating another exemplary vehicle micro-triangulation algorithm, which may correspond to memory-stored instructions that are executable by a resident or remote controller, control-logic circuit, programmable control unit, or other integrated circuit (IC) device or network of devices in accord with an embodiment of the disclosed concepts.

FIG. 5 is a flowchart illustrating a computer system upon which various embodiments may be implemented.

The present disclosure is amenable to various modifications and alternative forms, and some exemplary embodiments of the disclosure are shown by way of example in the drawings and will be described in detail herein. It should be understood, however, that the novel aspects of this disclosure are not limited to the particular forms illustrated in the above-enumerated drawings. Rather, this disclosure covers all modifications, equivalents, combinations, permutations, groupings, and alternatives falling within the scope of this disclosure as encompassed, for example, by the appended claims.

### DETAILED DESCRIPTION

The description of the preferred embodiments is intended to be read in connection with the accompanying drawings, which are to be considered part of the entire written description of this invention. The use of the singular includes the plural unless specifically stated otherwise. The use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. Additionally, the section headings used herein are for organizational purposes only, and are not to be construed as limiting the subject matter described. Numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The following description is provided as an enabling teaching of a representative set of examples. Many changes can be made to the embodiments described herein while still obtaining beneficial results. Some of the desired benefits discussed below can be obtained by selecting some of the features discussed herein without utilizing other features. Accordingly, many modifications and adaptations, as well as subsets of the features described herein are possible and can even be desirable in certain circumstances. Thus, the following description is provided as illustrative and is not limiting. To that extent, elements and limitations that are described, for example, in the Abstract, Introduction, Summary, and Detailed Description sections, but not explicitly set forth in the claims, should not be incorporated into the claims, singly or collectively, by implication, inference or otherwise.

The drawing figures are not necessarily to scale and certain features of the invention may be shown exaggerated in scale or in somewhat schematic form in the interest of clarity and conciseness. In this description, relative or directional terms such as “horizontal,” “vertical,” “up,” “down,” “top,” “bottom,” “fore,” “aft,” “inboard,” “outboard,” “starboard,” “port,” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. These relative terms can be interpreted with respect to a motor vehicle, such as a forward driving direction of a motor vehicle when the vehicle is operatively oriented on a horizontal driving surface. Terms concerning attachments, coupling and the like, such as “connected” and “interconnected,” refer to a relationship wherein structures are secured or attached to one another either directly or indirectly through intervening structures, as well as both moveable or rigid attachments or relationships, unless expressly described otherwise. The term “operatively coupled” is such an attachment, coupling, or connection that allows the pertinent structures to operate as intended by virtue of that relationship. The term “coupled” refers to any thermal, electrical, logical, or physical connection, link or the like by which signals, energy, or information produced or supplied by one element are imparted to another element. Unless described otherwise, coupled elements or devices are not necessarily directly connected to one another, and may be separated by intermediate components, elements, or media that may modify, manipulate, or carry the signals, energy, or information.

As used herein, the term “substantially” denotes elements having a recited relationship (e.g., parallel, perpendicular, aligned, etc.) within acceptable manufacturing tolerances. For example, as used herein, the term “substantially parallel” is used to denote elements that are parallel or that vary from a parallel arrangement within an acceptable margin of error, such as +/−5° or 5%, although it will be recognized that greater and/or lesser deviations can exist based on manufacturing processes and/or other manufacturing requirements.

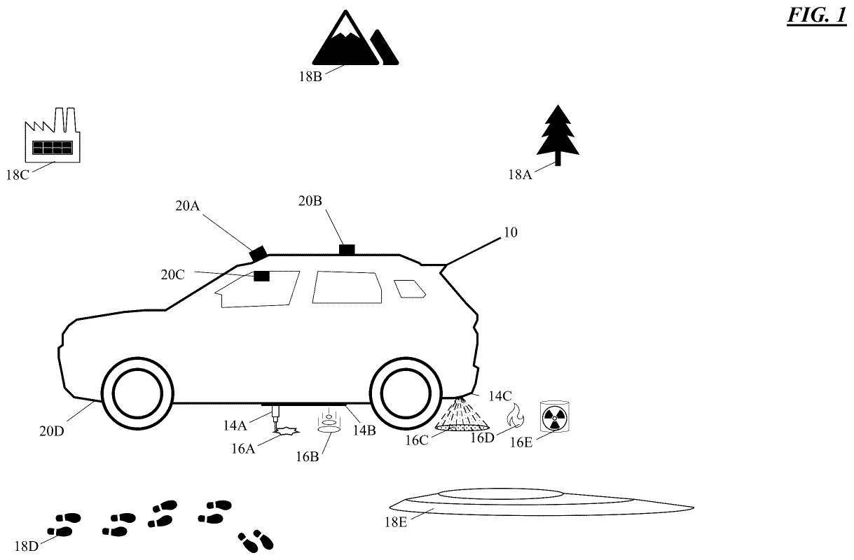

Referring now to the drawings, wherein like reference numbers refer to like features throughout the several views, there is shown, in FIG. 1, an exemplary motor vehicle 10, which is portrayed herein for purposes of discussion as an armored personnel carrier vehicle. The illustrated vehicle 10—also referred to herein as “motor vehicle” or alternatively “automobile”—is merely an exemplary application with which aspects of this disclosure may be practiced. Moreover, only select components of the motor vehicles and intelligent vehicle control systems are shown and described in additional detail herein. Nevertheless, the vehicles and systems discussed below may include numerous additional and alternative features, and other available peripheral components, for carrying out the various methods and functions of this disclosure.

In some embodiments, the exemplary vehicle 10 of FIG. 1 is equipped with one or more tagging units 14A-C. Tagging units 14A-C are components of the vehicle 10 capable of selectively tagging a physical area near the vehicle 10. In some embodiments, tagging can include a retractable arm tagging unit 14A drawing or etching a pattern into the surface of the terrain adjacent to the vehicle 10. In other embodiments, tagging can include a dispenser tagging unit 14B-C dispensing, launching, ejecting, or dropping a physical marker 16A-E onto the surface of the terrain adjacent to the vehicle 10, or onto an object near the vehicle 10. The physical marker 16B-E can include any type of perceptible object: some non-limiting examples include a cairn of rocks 16B, paint, water, or evaporable fluid 16C, ignited material 16D, or radioactive material 16E.

In some embodiments, the physical marker 16A-E is a clandestine marker. Clandestine markers include markers which are not visible to a typical human viewer, in some cases because the marker does not materially emit or refract light in the visible spectrum. Example non-visible markers can include paints or coatings which refract infrared light, and which are generally only readily visible to infrared viewing equipment. Alternatively, non-visible markers can include, for example, radioactive dust, which is too fine to materially refract light in a noticeably unique manner as compared to its environment, but is nevertheless readily visible or discernable via a radiation detector or a scintillation detector.

Clandestine markers include markers which are inconspicuous markers. Example inconspicuous markers include rocks or arrangements of rocks in an arid environment, spillage of water, camouflaged marking in the terrain (e.g., false animal footprints, bird feathers, discarded snake skin, boot prints matching those of boots issued to an opposing force, trash, animal waste, etc.) or other markers which could be expected in the environment by a typical person as a non-signifying object, but are configured such that an informed sub-group of people or vehicle 10 recognizes the marker (e.g., based on a pattern or orientation of the object which conforms to a predetermined conformance criteria) as a signifying object.

Clandestine markers include markers which are ephemeral markers. Example ephemeral markers include fires, spilled water, consumable local flora or fauna, markings drawn in topsoil, or a marker designed to be collected by a subsequent vehicle—which may be replaced by another marker.

Clandestine markers include markers which are inscrutable markers. An inscrutable marker includes markers which may readily appear to be a marker of some kind to a typical human viewer, but which conveys information unobservable or incomprehensible to a typical human viewer. Example inscrutable markers include metal stakes, RFID tags, laser emitters, or Bluetooth, Wi-Fi, or other wireless devices. Such inscrutable markers can broadcast encrypted information, and in some embodiments can be coupled to the vehicle 10 or other wireless communication device via a digital connection to upload or download data to the inscrutable marker. In some embodiments, inscrutable markers can include interior storage of physical information, or sufficient potential energy (i.e., explosives) to self-destruct or launch itself to another location.

Clandestine markers include markers which are symbolic markers. Example symbolic markers include patterns in paint, patterned drawings, dead drops, or patterned arrangements of locally perceptible phenomena (e.g., a cairn of rocks, a bundle of sticks, an arrangement of trash or waste). The purpose of the symbology of the marker can be to confirm to an observer the status of the clandestine marker as a marker (i.e., the vehicle 10 is instructed to flag seven-sided stars on the terrain as markers), or the symbology can convey additional information related to the marker (e.g., the producer of the marker, the date and time of the marking, local topographical information, directions to another marker, tactical information such as supply caches or opposing force positions and movements, etc.)

In some embodiments, a clandestine marker exhibits behavior from one or more of the above categories (invisible, inconspicuous, ephemeral, inscrutable, symbolic). For example, a drawing 16A made in topsoil by a retractable device 14A can be near-invisible, inconspicuous, ephemeral, and symbolic—such a drawing 16A matches the surrounding terrain, can be easily destroyed by later traffic, and can convey motion or the position of another marker. In another example, animal exuviae, whether genuine or manufactured, such as a snake's skin, can be inconspicuous, ephemeral, and symbolic—such a marker could be expected in a snake-inhabited environment, can be destroyed, consumed, or pulverized by the environment, and, particularly if manufactured or modified, can convey clandestine symbolic information in the patterns on the snakeskin.

In some embodiments, the vehicle 10 is configured to track one or more physical markers 16A-E or environmental objects 18A-E. Environmental objects 18A-E include objects or phenomena which exist prior to the vehicle 10 tracking the environmental object 18A-E. Examples of environmental objects 18A-E can include flora such as trees 18A, topographical features such as mountains 18B, or constructed structures such as factories 18C, or towers. Additionally, environmental objects 18A-E can include local environmental objects, such as travel paths or treads 18D, or local subtle topography 18E.

In some embodiments, the vehicle 10 tracks the physical markers 16A-E or environmental objects 18A-E via one or more sensors 20A-D. As disclosed above, the sensors 20A-D can include cameras, which can further include visible light cameras, infrared camera, or other spectrum cameras. Cameras can include single-direction mounted cameras, rotatable cameras, or 360-degree cameras or camera arrays. Sensors can include directional signaling equipment, such as lasers, scanners, and in some examples directional wireless emitters. Sensors can also include radiation sensors, humidity sensors, mass spectrometers, or other light or non-light phenomenon-sensing devices. The sensors 20A-B can be mounted on the top of the vehicle 10, within the vehicle 20C, or below the vehicle 20D. In some embodiments, the sensor 20A-B can change the elevation of the sensor relative to the vehicle 10, for example by being attached to a distal end of a vertically-telescoping element. In certain embodiments, the vehicle includes a drone, either tether or untethered, which includes the sensor 20A-D and collects data on behalf of the vehicle 10. In environments where wireless communication is prohibited, the drone can communicate data via the tether if the drone is tethered. Alternatively, the drone can capture information while in flight, and once berthed back in the vehicle 10, the drone can then communicate information to the vehicle 10 via a direct non-wireless connection (or a shielded wireless connection if, for example, the berth includes a Faraday Cage) within the berth.

In some embodiments, the sensors 20A-D track the physical markers 16A-E or environmental objects 18A-E by identifying the physical markers 16A-E or environmental objects 18A-E as flagged objects. Next, the sensors, in concert with other elements of the vehicle 10, determine a vector describing the relationship between the flagged object and the vehicle 10. The vector can include angular or directional data, and can maintain the angular or directional data as relative to a compass direction, a compass reading, or the current directionality of the vehicle 10 or the sensor 20A-D. In some embodiments, the vector data can include a magnitude or distance between the flagged object and the vehicle 10. The distance can be determined if the sensor 20A-D and accompanying software are configured to either determine distance based on a measurement (i.e., a stereo camera, a directed LiDAR beam and reflection), to determine distance based on a perceived change in properties of the flagged object (i.e. a tree 18A appears half as large, so it is twice as far away), to determine distance based on known coordinates of the flagged object or the vehicle 10 (i.e., a cairn 16B is dropped by the vehicle 10, and then the vehicle 10 moves six feet, thus the cairn 16B is six feet from the vehicle 10), or a combination thereof. It should be emphasized that in such embodiment, the sensor 20A-D can be a simple camera or photoreceptor module. Further, in some embodiments a combination of determinations can collaborate to collectively determine a distance, and in other embodiments some determinations are used to verify other determinations. For example, if the vehicle 10 draws a drawing 16A and drives six feet away, a sensor 20D can triangulate a future distance of the drawing 16A from the vehicle 10 based on the relative perceived size of the drawing 16A at six feet and the future perceived size of the drawing 16A. In another example, the vehicle 10 can determine based on perceived size of a fire physical marker 16D that the fire is at a certain distance, and then the vehicle can verify that distance by using an infrared thermometer. In such an example, the infrared thermometer may not be able to determine a precise distance, based on the fact that the fire can have consumed a variable amount of fuel, but the infrared thermometer can determine a reasonable distance range, and the relative size measure can be compared to that reasonable range: if the relative size measure falls outside the reasonable range, it is possible that the relative size measuring sensor either incorrectly identified the size of the fire physical marker 16D, or incorrectly identified the fire physical marker 16D entirely.

In some embodiments, certain flagged objects can be utilized as local confirmatory objects, while others are utilized as landmarks. For example, the vehicle 10 may track a vector relative to the mountain 18B. When attempting to determine more precise coordinates of the vehicle 10, the vehicle 10 can, based on the mountain-relative vector, determine an area within which the vehicle 10 is currently located. The mountain-relative vector may indicate the vehicle is between 23 and 24 degrees south-southeast of the mountain 18B, and is at a distance of 39.5 to 39.8 miles. Using these measurements, the vehicle 10 can determine it resides within a compass arc segment approximately 1 degree wide, 0.3 miles in radius, 39.5 miles from the mountain, with an approximate area of a quarter mile. The vehicle 10 can then consult an internal map of flagged objects to determine whether any are within or visible from within the compass arc segment, such as local subtle topography 18E. Upon determining that a particular flagged object should be within or visible from within the compass arc segment, the vehicle 10 can identify and flag that object in order to determine precise coordinates.

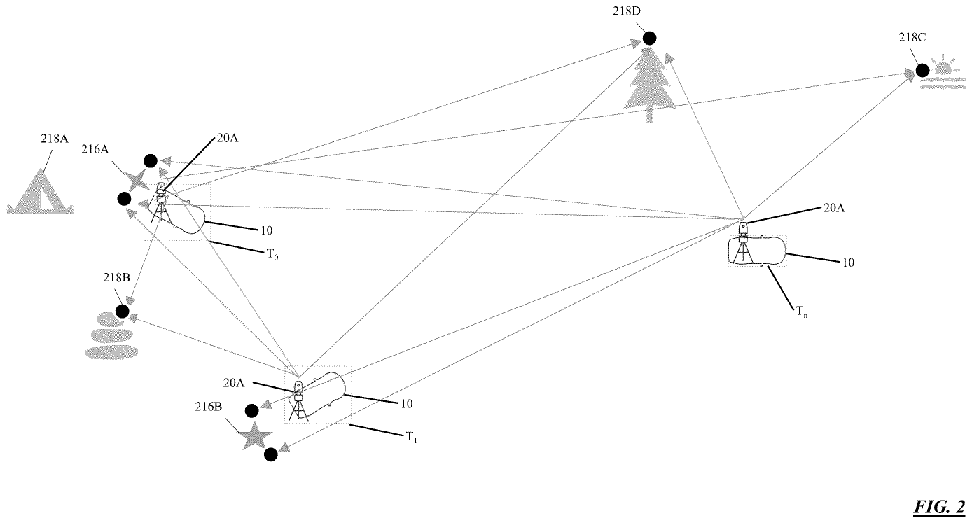

With reference next to the map of FIG. 2, a vehicle 10 traversing an area over multiple time intervals (T₀, T₁, Tₙ) is depicted. The vehicle 10 maintains knowledge of its relative (or absolute) coordinates at each time interval by tracking and discerning flagged tags 216A-B, 218A-D and vectors between the vehicle 10 and those discerning flagged tags 216A-B, 218A-D.

The vehicle 10 or sensor 20A discerning an object includes capturing visual information, such as an image or video feed, and also identifying or sensing the object or a lack of that object in the captured visual information. For example, discerning the tree 18A includes capturing an image including visual or pixel information which depicts the tree 18A. The vehicle 10 or sensor 20A has not deliberately captured an image of the tree 18A, as the presence or absence of the tree 18A in the image has not yet been discerned—however the vehicle 10 or sensor 20A can be intending or attempting to capture an image of the tree 18A, based on previously acquired information such as the (general or exact) prior location of the tree 18A relative to the vehicle 10 or sensor 20A. Next, the vehicle 10 searches through the captured image for visual facets or features of the tree 18A in the captured image. In some examples, the image is pixelated, and the searching is performed by reviewing the pixels in some sequence, visual facets or features can include patterns of pixels which the vehicle 10 or sensor 20A has been configured to identify as the tree 18A, using conventional computer vision systems and methods. Once visual facets or features of the tree 18A are identified to a sufficient degree of confidence, the vehicle 10 or sensor 20A has discerned that the tree 18A is in the captured image, and can report or output the presence of the tree 18A in the image, and in some embodiments the location of the tree 18A in the image.

In some examples, the vehicle 10 or sensor 20A discerns mathematical properties such as angles or vectors—in such examples, the vehicle 10 captures visual information, identifies one or more objects in the captured visual information, and then calculates the mathematical property based on the identified one or more objects. For example, discerning an angular vector to the tree 18A first includes discerning the tree 18A and the location of the tree 18A in a captured image as described above. Next, the vehicle 10 or sensor 20A determines the angle at which the image was captured relative to some reference angle, and subsequently calculates the angle of the tree 18A position within the captured image relative to some reference angle. Thus, the vehicle 10 or sensor 20A has discerned the angle of the tree 18A as the angle of the sensor 20A relative to a reference angle, with additional precision calculated by determining the angle of the tree 18A position within the image captured by the sensor 20A.

At T₀, the vehicle 10 flags several tags. First, the vehicle 10 draws a drawing 216A at the location of the vehicle at T₀. The vehicle also flags a cairn 218B, a treetop 218D, and a point on the horizon 218C. The vehicle 10 can consider its position at T₀ an initial position, e.g., (0,0,0). In some embodiments, the vehicle 10 can also interact with a base 218A. The vehicle 10 can use the base 218A as another tag. The vehicle 10, if using the base 218A as a tag, can be informed by the base 218A or by prior stored records of the geographic coordinates of the base 218A, which would provide an absolute position of the base 218A on the coordinate plane (i.e., the Global Positioning System latitude and longitude grid.) The vehicle 10 can then calculate the geographic coordinates location of the vehicle at T₀ based on triangulation with the base 218A with known coordinates, or can adopt or adjust the geographic coordinates of the base 218A as the coordinates of the location of the vehicle at T₀. At T₀, the vehicle 10 has calculated at least angle vectors (with or without distance components) to the cairn 218B, the horizon 218C, and the treetop 218D from the position of the vehicle 10 at T₀.

Between T₀ and T₁, the vehicle 10 navigates or moves to the location of the vehicle at T₁. During this time period, the vehicle 10 can periodically re-flag the tags 216A, 218B-D. The vehicle can also determine a distance and direction traveled based on the compass angle of the vehicle 10 and the amount of wheel rotation experienced between T₀ and T₁. If the vehicle 10 travels in a perfectly straight line during the period of time between T0 and T₁, then the distance travelled and the angle travelled at can be used to determine update coordinates of the vehicle at T₁. However, because traversing terrain can result in the traversing vehicle 10 travelling in a straight line and a single angle, coordinates of the vehicle location at T₁ determined based solely on the position of the vehicle at T₀, and the distance and angle traveled between T₀ and T₁ can have discrepancies.

It should be noted that “wheel rotation” can include measurement of force exhibited by a vehicle 10, including embodiments of vehicle 10 which do not include wheels configured to make contact with a normal surface for directed movement. For example, “wheel rotation” can include any measured data captured by an accelerometer. “Wheel rotation” and accelerometer data can include the rotation of a propeller on a watercraft, a fuel consumption rate of a vehicle 10, data from an anemometer, or any measure of force, acceleration, or effort caused by or experienced by the vehicle 10 either resulting in an actual change in the vehicle 10 position relative to a point or plane of reference, or intending to cause a change in the vehicle 10 position relative to the point or plane of reference.

In order to correct for such discrepancies, or in embodiments where vehicle 10 angle of travel and wheel rotation are not utilized in determining subsequent vehicle 10 coordinates, updated tag vectors are discerned and compared to prior vectors in order to determine distance travelled. As discussed above, multiple calculations or estimates can be performed, and an average or weighted average can be utilized to determine the vehicle coordinates at T₁.

For example, at T₀ when the vehicle 10 produced the drawing 216A, the drawing 216A was produced with a known width or dimensionality, called W_{actual}. Later, at T₁, the vehicle 10, using sensor 20A, can determine a visible left edge and a visible right edge of the drawing 216A, and can therefore determine a width of the drawing 216A as perceived by sensor 20A, or W_{image}. If the vehicle knows the focal length f of the sensor 20A, the vehicle can calculate a distance from the drawing 216A. Using a compass or heading of the vehicle 10, the vehicle 10 can determine an angle relative to a reference (i.e., true north or compass north). With the calculated distance and angle, and the coordinates of the drawing 216A, the vehicle 10 can perform vector math to arrive at the coordinates of the vehicle 10 at T₁.

The vehicle 10 can confirm, supplement, or alternatively calculate coordinates using multiple angular vectors. Using two angular vectors at T₀, the vehicle 10 can calculate a first relative triangle based on the angle of the first vector, the angle of the second vector, and a finite (but potentially unknown) length of a triangle side between the subject of the first vector and the subject of the second vector. The vehicle 10 can assign known coordinates at T₀ to the vertex of the first relative triangle facing the finite triangle side (i.e., the location of the vehicle 10 at T₀). At T₁, the vehicle can discern two revised angular vectors pointing to the subject of the first vector and the subject of the second vector. As the subjects of the vectors have not moved between T₀ and T₁, a second relative triangle based on the angle of the first vector, the angle of the second vector, and the length of the triangle side between the subject of the first vector and the subject of the second vector can be calculated. As the first relative triangle and the second relative triangle share a side, a vector between the vertex of the first relative triangle facing the shared side and the vertex of the second relative triangle facing the shared side can be calculated. That angular vector can be combined with the wheel rotation distance between T₀ and T₁ to apply a magnitude to the calculated angular vector, thereby providing a vector with both angle and distance travelled between T₀ and T₁, allowing calculation of coordinates of the vehicle at T₁. If the time between T₀ and T₁ is relatively small, deviations from a perfect line between T₀ and T₁ are less likely. The calculated vector can also be used to determine a distance between the subject of the first vector and the subject of the second vector. Repeated discernments and calculations can revise and improve the calculated distance between the subject of the first vector and the subject of the second vector, thereby providing additional geometric data allowing for improved coordinate calculations throughout the field and between flagged objects 216A-B, 218B-D.

At T₁, the vehicle 10 draws another drawing 216B. The vehicle relies on the change in vectors at T₁ towards landmarks 218B-D, as well as the vectors toward and the known width of drawing 216A, to determine the coordinates at T₁ to be associated with drawing 216B.

Between T₁ and Tₙ, the vehicle 10 navigates or moves to the location of the vehicle 10 at Tₙ. The vehicle 10, now flagging two objects of known width (drawings 216A-B), can improve the precision, robustness, or reliability of coordinates determined at Tₙ. Vehicle 10 may be able to utilize geometry to calculate coordinates for landmarks 218B-D, which can assist in future navigation, or navigation when drawings 216A-B are obscured or destroyed. Thus, vehicle 10 can create a coordinate graph or map both of markers 216A-B as well as landmarks 218B-D, despite not knowing initially the coordinates of landmarks 218B-D. Such a coordinate graph or map is robust, as alterations to markers 216A-B or landmarks 218B-D nevertheless results in a coordinate graph or map usable for subsequent navigation.

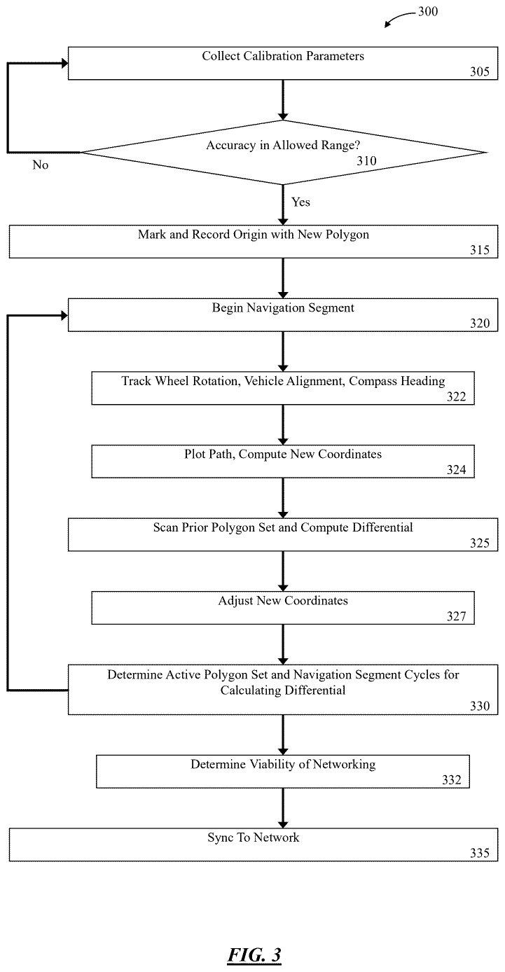

With reference next to the flowchart of FIG. 3, a method 300 is disclosed for determining coordinate data of a vehicle 10 over multiple time intervals. In block 305, the vehicle collects calibration parameters. Calibration parameters can include current coordinates, including geographic coordinates, provided either by a Global Positioning System or by a trusted device with known coordinates. Calibration parameters can include any maps or graphs of known landmarks 18A-E or physical markers 16A-E already present in the area of operation, and any coordinates of those flagged objects, any known dimensions of those flagged objects, or any collected vectors and pathing, angle, and wheel rotation data from other vehicles which have traversed the area of operation. The maps can include a bearing map: if a compass device on the vehicle 10 is used in navigating and calculating coordinates, the vehicle 10 can benefit from knowledge of localized deviations of the magnetic field which can be captured in a bearing map. The bearing map can be based on pre-navigation data, or can be updated based on large magnetic field-generating objects in the area of operation.

In block 310, the vehicle 10 determines whether the accuracy of the calibrated data is within an allowed range. If the vehicle 10 has inaccurate calibration data, for example inaccurate compass readings or inaccurate focal point data of the sensor 20A, then subsequent readings and discernments can be flawed and can be useless or actively mislead the vehicle 10 and subsequent vehicles, as well as damage or degrade the data set of coordinates, paths, and vectors (captured either by the vehicle 10 or multiple vehicles.) If the vehicle 10 does not have accurately calibrated data, the method 300 returns to block 305. If the vehicle 10 is sufficiently calibrated and accurate, the method 300 proceeds to block 315.

In block 315, the vehicle 10 marks and records its point of origin (i.e., location at T₀) with a drawn polygon (e.g., drawing 216A). In some embodiments, the drawn polygon has a known dimensionality in order to assist with later calculations.

In block 320, the vehicle 10 begins a navigation segment, which can include navigating from a location at T₀ to a location at T₁. If referring to FIG. 2, the distance between navigation segments can appear substantial, at least several times the length of vehicle 10. However, a navigation segment can also be a relatively short distance or period of time. Shorter distances or period of time will require more computing power, as calculations will occur more frequently, but inaccuracies due to the vehicle 10 drifting or differing from a mathematically perfect path will be reduced, or can be more easily identified and corrected for. For example, if a navigation segment includes one hundred wheel rotations, and if ten wheel rotations are at elevation or in a slipping environment, then the distance measured could be off by as much as 10% or more. However, if a navigation segment includes a single wheel rotation, then over one hundred single-wheel-rotation navigation segments, ten segments with inaccurate distance measurements can be particularly identified based on measurement discrepancies between flagged object measurements as compared to the ninety other navigation segments, and can be discarded or revised.

In block 322, during the navigation segment the vehicle 10 tracks wheel rotation, vehicle alignment and compass heading, for the purpose of calculating a more accurate path traversed during the navigation segment. If the data is collected at a fairly high periodicity, inaccuracies due to measurement drift can be reduced. In some embodiments, the vehicle 10 also tracks vehicle incline, in order to capture topographical data and reduce coordinate drift in later blocks.

In block 324, the path is plotted based on the tracked wheel rotation, vehicle alignments, and compass headings, and plotted coordinates based on the plotted path are computed.

In block 325, the prior polygon set (including at this point drawing 216A) is rescanned by the sensor 20A, vectors to the polygon or polygons are calculated, and a differential between the plotted coordinates and the calculated coordinates are computed.

In block 327, the coordinates of the location at T₁ are set or adjusted based on the plotted coordinates, the calculated coordinates, and the differential. If the plotted coordinates are determined to be less accurate than the calculated coordinates, the plotted path can be adjusted, stretched, or skewed to properly connect the coordinates at T₀ with the coordinates at T₁. The plotted path can also be adjusted based on topographical data either previously possessed by the vehicle 10, or captured by the vehicle 10 during the navigation segment. For example, if the vehicle 10 travelled along a ridge during the navigation segment, the plotted path can be adjusted while still depicting the vehicle 10 as having travelled along the ridge, rather than off or through the ridge.

In block 330, the vehicle 10 determines the active polygon set and navigation segment cycles for calculating differential corrections. For example, if a flagged polygon or drawing 216A from the beginning of the navigation segment cannot be discerned, then the flagged polygon or drawing 216A may not be usable to perform confirmatory calculations, or cannot be used in a subsequent navigation segment. Additionally, if material differential has been detected between the calculated coordinates and the plotted coordinates, the vehicle 10 can then determine how many additional navigation segments, which will include vector discernments of one or more existing polygons (i.e., drawing 216A), are needed to establish a quorum of accurate measurements and to correct for that material differential. Upon completing block 330, the method 300 returns to block 320. Once the vehicle 10 has completed traversing navigation segments, the method proceeds to block 332.

In block 332, the vehicle 10 determines whether a network can be viably accessed. Viability here can mean that it is technically or physically possible to access a network, and can also mean that it is prudent or tactical to broadcast or otherwise communicate in order to access the network.

In block 335, if it is viable to access a network, the vehicle 10 syncs the collected navigation data to the network, and additionally can download navigation data collected from other vehicles which may be relevant to vehicle 10.

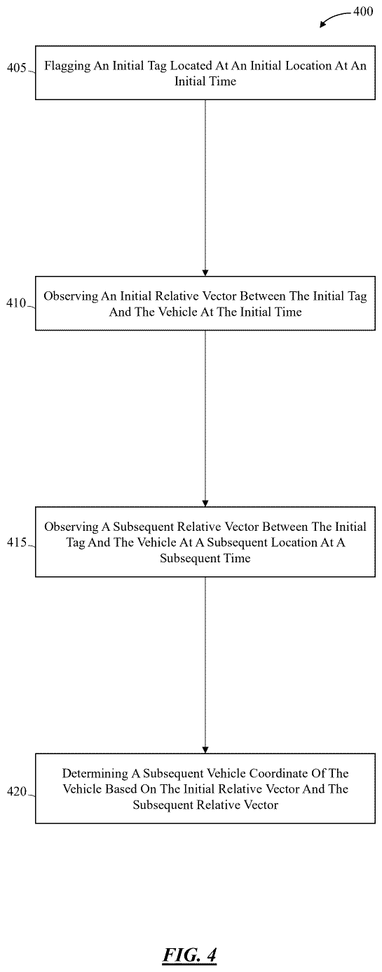

FIG. 4 illustrates an example process 400 performed by a computer or onboard application module of a vehicle 10 in accordance with disclosed embodiments.

In block 405, the vehicle flags an initial tag located at an initial location at an initial time. In some embodiments, flagging the initial tag at the initial location at the initial time further comprises physically modifying the initial location. In a subset of those embodiments, physically modifying the initial location includes applying a physical marker to the initial location. In a further subset of those embodiments, the physical marker emits or reflects energy, and the vehicle discerns the second relative vector based on the energy. In another subset of some embodiments, physically modifying the initial location includes performing a modification that is impermanent. In yet another subset of some embodiments, physically modifying the initial location includes performing a modification that is camouflaged. In a different subset of some embodiments, physically modifying the initial location includes moving a physical object at the initial location. In a further subset of those embodiments, moving a physical object at the initial location includes mechanically drawing a shape in a surface of the initial location via a retractable device of the vehicle.

A physical object can include a clandestine marker as described above, created, marked, or placed by the vehicle or another entity. The physical object can include any kind of perceivable phenomena, and can be perceived by action of a sensor (e.g., a touch initiated by a sensor) or by reaction of a sensor to an emission or redirection of energy or information from another phenomena. Examples of physical objects include buildings, rocks, mountains, water, people, animals, groups of people or animals, mirrors, celestial objects, other vehicles, satellites, moisture, steam, smoke, fire, mirage, paint, ink, heat, radiation, gas pressure, liquid pressure, electromagnetism, electricity, or any emission thereof.

In certain embodiments, flagging the initial tag at the initial location at the initial time further comprises identifying a physical object at the initial location via a sensor. In a subset of those embodiments, the sensor is a passive sensor.

In block 410, the vehicle discerns an initial relative vector between the initial tag and the vehicle at the initial time. In some embodiments, the vehicle determines an initial vehicle coordinate of the vehicle based on the initial relative vector. The vehicle is also moved to a subsequent location after the initial time. In certain embodiments, the vehicle tracks a wheel rotation of a wheel of the vehicle while the vehicle is moved.

In block 415, the vehicle discerns a subsequent relative vector between the initial tag and the vehicle at a subsequent location at a subsequent time.

In block 420, the vehicle determines a subsequent vehicle coordinate of the vehicle based on the initial relative vector and the subsequent relative vector. In some embodiments, determining the subsequent vehicle coordinate of the vehicle is further based on the initial relative vector, the subsequent relative vector, and the initial vehicle coordinates. In certain embodiments, determining the subsequent vehicle coordinate of the vehicle is further based on the subsequent relative vector and the wheel rotation. In some embodiments, the subsequent vehicle coordinate is a relative coordinate.

In some embodiments, the vehicle determines an initial vehicle coordinate of the vehicle at a preliminary location by coupling with a Global Positioning System, the preliminary vehicle coordinate a geographic coordinate. The vehicle also determines a geographic subsequent vehicle coordinate based on the initial relative vector, the subsequent relative vector, and the initial vehicle coordinate.

In certain embodiments, the vehicle discerns an ultimate relative vector between a subsequent tag and the vehicle at an ultimate location at an ultimate time. The vehicle determines an ultimate vehicle coordinate of the vehicle at the ultimate location by coupling with a Global Positioning System, the ultimate vehicle coordinate a geographic coordinate. The vehicle then determines a geographic subsequent vehicle coordinate of the vehicle based on the subsequent relative vector, the ultimate relative vector, and the ultimate vehicle coordinate.

In some embodiments, the vehicle flags a reference tag. The vehicle discerns an initial reference vector between the reference tag and the vehicle at the initial time. The vehicle discerns a subsequent reference vector between the reference tag and the vehicle at the subsequent location at the subsequent time. The vehicle determines the subsequent vehicle coordinate of the vehicle based on the initial relative vector, the subsequent relative vector, the initial reference vector, and the subsequent reference vector.

In some embodiments, the vehicle receives a reference coordinate of the initial tag. The vehicle determines a geographic initial vehicle coordinate of the vehicle is based on the initial relative vector and the reference coordinate.

In some embodiments, determining the subsequent vehicle coordinate of the vehicle is further based on the initial relative vector, the subsequent relative vector, a compass reading, and a bearing map.

In some embodiments, discerning the initial reference vector at the initial time is by an initial sensor of the vehicle, the initial sensor at an initial height relative to the vehicle at the initial time. Discerning the subsequent reference vector at the subsequent time is by a subsequent sensor of the vehicle, the subsequent sensor at a subsequent height relative to the vehicle. The initial height is unequal to the subsequent height. In some embodiments, the initial sensor and the subsequent sensor are the same sensor.

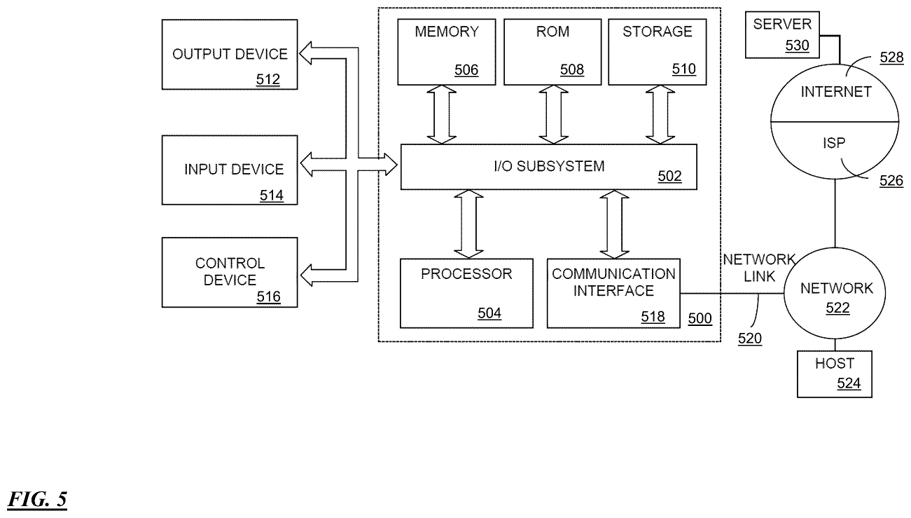

FIG. 5 is a block diagram that illustrates an example computer system with which an embodiment may be implemented. In the example of FIG. 5, a computer system 500 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 500 includes an input/output (I/O) subsystem 502 which may include a bus and/or other communication mechanism(s) for communicating information and/or instructions between the components of the computer system 500 over electronic signal paths. The I/O subsystem 502 may include an I/O controller, a memory controller and at least one I/O port. The electronic signal paths are represented schematically in the drawings, for example as lines, unidirectional arrows, or bidirectional arrows.

At least one hardware processor 504 is coupled to I/O subsystem 502 for processing information and instructions. Hardware processor 504 may include, for example, a general-purpose microprocessor or microcontroller and/or a special-purpose microprocessor such as an embedded system or a graphics processing unit (GPU) or a digital signal processor or ARM processor. Processor 504 may comprise an integrated arithmetic logic unit (ALU) or may be coupled to a separate ALU.

Computer system 500 includes one or more units of memory 506, such as a main memory, which is coupled to I/O subsystem 502 for electronically digitally storing data and instructions to be executed by processor 504. Memory 506 may include volatile memory such as various forms of random-access memory (RAM) or other dynamic storage device. Memory 506 also may be used for storing temporary variables or other intermediate information during execution of instructions to be executed by processor 504. Such instructions, when stored in non-transitory computer-readable storage media accessible to processor 504, can render computer system 500 into a special-purpose machine that is customized to perform the operations specified in the instructions.

Computer system 500 further includes non-volatile memory such as read only memory (ROM) 508 or other static storage device coupled to I/O subsystem 502 for storing information and instructions for processor 504. The ROM 508 may include various forms of programmable ROM (PROM) such as erasable PROM (EPROM) or electrically erasable PROM (EEPROM). A unit of persistent storage 510 may include various forms of non-volatile RAM (NVRAM), such as FLASH memory, or solid-state storage, magnetic disk, or optical disk such as CD-ROM or DVD-ROM, and may be coupled to I/O subsystem 502 for storing information and instructions. Storage 510 is an example of a non-transitory computer-readable medium that may be used to store instructions and data which when executed by the processor 504 cause performing computer-implemented methods to execute the techniques herein.

The instructions in memory 506, ROM 508 or storage 510 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement Transmission Control Protocol/Internet Protocol (TCP/IP), Hypertext Transfer Protocol (HTTP) or other communication protocols; file processing instructions to interpret and render files coded using HTML, Extensible Markup Language (XML), Joint Photographic Experts Group (JPEG), Moving Picture Experts Group (MPEG) or Portable Network Graphics (PNG); user interface instructions to render or interpret commands for a GUI, command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or NoSQL, an object store, a graph database, a flat file system or other data storage.

Computer system 500 may be coupled via I/O subsystem 502 to at least one output device 512. In one embodiment, output device 512 is a digital computer display. Examples of a display that may be used in various embodiments include a touch screen display or a light-emitting diode (LED) display or a liquid crystal display (LCD) or an e-paper display. Computer system 500 may include other type(s) of output devices 512, alternatively or in addition to a display device. Examples of other output devices 512 include printers, ticket printers, plotters, projectors, sound cards or video cards, speakers, buzzers or piezoelectric devices or other audible devices, lamps or LED or LCD indicators, haptic devices, actuators, or servos.

At least one input device 514 is coupled to I/O subsystem 502 for communicating signals, data, command selections or gestures to processor 504. Examples of input devices 514 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, biometric sensors, pulse sensors, kinematic sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 516, which may perform cursor control or other automated control functions such as navigation in a graphical interface on a display screen, alternatively or in addition to input functions. Control device 516 may be a touchpad, a mouse, a trackball, or cursor direction keys for communicating direction information and command selections to processor 504 and for controlling cursor movement on the output device 512. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 514 may include a combination of multiple different input devices, such as a video camera and a depth sensor.

In another embodiment, computer system 500 may comprise an internet of things (IoT) device in which one or more of the output device 512, input device 514, and control device 516 are omitted. Or, in such an embodiment, the input device 514 may comprise one or more cameras, motion detectors, thermometers, microphones, seismic detectors, other sensors or detectors, measurement devices or encoders and the output device 512 may comprise a special-purpose display such as a single-line LED or LCD display, one or more indicators, a display panel, a meter, a valve, a solenoid, an actuator or a servo.

When computer system 500 is a mobile computing device, input device 514 may comprise a global positioning system (GPS) receiver coupled to a GPS module that is capable of triangulating to a plurality of GPS satellites, determining and generating geo-location or position data such as latitude-longitude values for a geophysical location of the computer system 500. Output device 512 may include hardware, software, firmware, and interfaces for generating position reporting packets, notifications, pulse or heartbeat signals, or other recurring data transmissions that specify a position of the computer system 500, alone or in combination with other application-specific data, directed toward host computer 524 or server 530.

Computer system 500 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 500 in response to processor 504 executing at least one sequence of at least one instruction contained in main memory 506. Such instructions may be read into main memory 506 from another storage medium, such as storage 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage 510. Volatile media includes dynamic memory, such as memory 506. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 502. Transmission media can also take the form of acoustic or light waves, such as those generated during radio-wave and infra-red data communications.

Various forms of media may be involved in carrying at least one sequence of at least one instruction to processor 504 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 500 can receive the data on the communication link and convert the data to be read by computer system 500. For instance, a receiver such as a radio frequency antenna or an infrared detector can receive the data carried in a wireless or optical signal and appropriate circuitry can provide the data to I/O subsystem 502 such as place the data on a bus. I/O subsystem 502 carries the data to memory 506, from which processor 504 retrieves and executes the instructions. The instructions received by memory 506 may optionally be stored on storage 510 either before or after execution by processor 504.

Computer system 500 also includes a communication interface 518 coupled to I/O subsystem 502. Communication interface 518 provides a two-way data communication coupling to network link(s) 520 that are directly or indirectly connected to at least one communication network, such as a network 522 or a public or private cloud on the Internet. For example, communication interface 518 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 522 broadly represents a LAN, WAN, campus network, internetwork, or any combination thereof. Communication interface 518 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 518 sends and receives electrical, electromagnetic, or optical signals over signal paths that carry digital data streams representing various types of information.

Network link 520 typically provides electrical, electromagnetic, or optical data communication directly or through at least one network to other data devices, using, for example, satellite, cellular, Wi-Fi, or BLUETOOTH technology. For example, network link 520 may provide a connection through a network 522 to a host computer 524.

Furthermore, network link 520 may provide a connection through network 522 or to other computing devices via internetworking devices and/or computers that are operated by an Internet Service Provider (ISP) 526. ISP 526 provides data communication services through a world-wide packet data communication network represented as internet 528. A server 530 may be coupled to internet 528. Server 530 broadly represents any computer, data center, virtual machine, or virtual computing instance with or without a hypervisor, or computer executing a containerized program system such as DOCKER or KUBERNETES. Server 530 may represent an electronic digital service that is implemented using more than one computer or instance and that is accessed and used by transmitting web services requests, URL strings with parameters in HTTP payloads, application programming interface (API) calls, app services calls, or other service calls. Computer system 500 and server 530 may form elements of a distributed computing system that includes other computers, a processing cluster, server farm or other organization of computers that cooperate to perform tasks or execute applications or services. Server 530 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to interpret or render files coded using HTML, XML, JPEG, MPEG or PNG; user interface instructions to render or interpret commands for a GUI, command-line interface or text user interface; application software such as an office suite, internet access applications, design and manufacturing applications, graphics applications, audio applications, software engineering applications, educational applications, games or miscellaneous applications. Server 530 may comprise a web application server that hosts a presentation layer, application layer and data storage layer such as a relational database system using structured query language (SQL) or NoSQL, an object store, a graph database, a flat file system or other data storage.

Computer system 500 can send messages and receive data and instructions, including program code, through the network(s), network link 520 and communication interface 518. In the Internet example, a server 530 might transmit a requested code for an application program through Internet 528, ISP 526, local network 522 and communication interface 518. The received code may be executed by processor 504 as it is received, and/or stored in storage 510, or other non-volatile storage for later execution.

The execution of instructions as described in this section may implement a process in the form of an instance of a computer program that is being executed, and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 504. While each processor 504 or core of the processor executes a single task at a time, computer system 500 may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

In the foregoing specification, embodiments of the disclosure have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Exemplary embodiments of the subject matter described in this specification, such as, but not limited to protocol 500 can be implemented as one or more computer programs, i.e., one or more modules of computer program instructions encoded on a tangible non-transitory program carrier for execution by, or to control the operation of, a data processing apparatus (or a computer system). According to some embodiments, “function,” “functions,” “application,” “applications,” “instruction,” “instructions,” or “programming” are program(s) that execute functions defined in the programs. Various programming languages can be employed to create one or more of the applications, structured in a variety of manners, such as object-oriented programming languages (e.g., Objective-C, Java, or C++), procedural programming languages (e.g., C or assembly language), or firmware. In a specific example, a third-party application (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application can invoke API calls provided by the operating system to facilitate functionality described herein.

Additionally, or alternatively, the program instructions can be encoded on an artificially generated propagated signal, such as a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

Hence, a machine-readable medium may take many forms of tangible storage medium. Non-volatile storage media include, for example, optical or magnetic disks, such as any of the storage devices in any computer(s) or the like, such as may be used to implement the client device, media gateway, transcoder, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge including flash or semiconductor memory devices, special purpose logic circuitry, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The terms “apparatus,” “device,” and “system” refer to data processing hardware and encompass all kinds of apparatus, devices, and machines for processing data, including, by way of example, a programmable processor such as a graphical processing unit (GPU) or central processing unit (CPU), a computer, or multiple processors or computers. The apparatus, device, or system can also be or further include special purpose logic circuitry, such as an FPGA (field programmable gate array) or an ASIC (application specific integrated circuit). The apparatus, device, or system can optionally include, in addition to hardware, code that creates an execution environment for computer programs, such as code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data, such as one or more scripts stored in a markup language document, in a single file dedicated to the program in question, or in multiple coordinated files, such as files that store one or more modules, sub programs, or portions of code. A computer program can be deployed to be executed on one computer or on multiple computers that are located at one site or distributed across multiple sites and interconnected by a communication network.

The processes, protocols, and logic flows described in this specification can be performed by one or more programmable computers executing one or more computer programs to perform functions by operating on input data and generating output. The processes, protocols, and logic flows can also be performed by, and apparatus can also be implemented as, special purpose logic circuitry, such as an FPGA (field programmable gate array), an ASIC (application specific integrated circuit), one or more processors, or any other suitable logic.

Computers suitable for the execution of a computer program include, by way of example, general or special purpose microprocessors or both, or any other kind of central processing unit (e.g., processor 504). Generally, a CPU will receive instructions and data from a read only memory or a random-access memory or both. The essential elements of a computer are a central processing unit for performing or executing instructions and one or more memory devices for storing instructions and data (e.g., memory 506). Generally, a computer will also include, or be operatively coupled to receive data from or transfer data to, or both, one or more mass storage devices for storing data, such as magnetic, magneto optical disks, or optical disks (e.g., secondary memory 508, 510). However, a computer need not have such devices. Moreover, a computer can be embedded in another device, such as a mobile telephone, a personal digital assistant (PDA), a mobile audio or video player, a game console, a Global Positioning System (GPS) receiver, or a portable storage device, such as a universal serial bus (USB) flash drive, to name just a few.

To provide for interaction with a user, embodiments of the subject matter described in this specification can be implemented on a computer having a display unit, such as a CRT (cathode ray tube) or LCD (liquid crystal display) monitor, for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back end component, such as a data server, or that includes a middleware component, such as an application server, or that includes a front end component, such as a computer having a graphical user interface or a Web browser through which a user can interact with an implementation of the subject matter described in this specification, or any combination of one or more such back end, middleware, or front end components. The components of the system can be interconnected by any form or medium of digital data communication, such as a communication network. Examples of communication networks include a local area network (LAN) and a wide area network (WAN), such as the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, such as an HTML page, to a user device, such as for purposes of displaying data to and receiving user input from a user interacting with the user device, which acts as a client. Data generated at the user device, such as a result of the user interaction, can be received from the user device at the server.

While this specification includes many specifics, these should not be construed as limitations on the scope of the invention or of what may be claimed, but rather as descriptions of features specific to particular embodiments of the invention. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow.

Further, other embodiments will be apparent to those skilled in the art from consideration of the specification and practice of one or more embodiments of the present disclosure. It is intended, therefore, that this disclosure and the examples herein be considered as exemplary only, with a true scope and spirit of the disclosed embodiments being indicated by the following listing of exemplary claims.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, element, block, step, feature, object, benefit, advantage, or equivalent to the public, regardless of whether it is or is not recited in the claims. It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises or includes a list of elements, blocks, or steps does not include only those elements, blocks, or steps but may include other elements, blocks, or steps not expressly listed or inherent to such process, method, article, or apparatus. An element preceded by “a” or “an” does not, without further constraints, preclude the existence of additional identical elements in the process, method, article, or apparatus that comprises the element unless the context clearly and unambiguously dictates otherwise.

Unless otherwise stated, any and all measurements, values, ratings, positions, magnitudes, sizes, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as ±10% from the stated amount.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

1. A method of determining a position of a vehicle, comprising:
flagging, by the vehicle, an initial tag located at an initial location at an initial time;
discerning, by the vehicle, an initial relative vector between the initial tag and the vehicle at the initial time;
discerning, by the vehicle, a subsequent relative vector between the initial tag and the vehicle at a subsequent location at a subsequent time; and
based on the initial relative vector and the subsequent relative vector, determining a subsequent vehicle coordinate of the vehicle.

2. The method of claim 1, further comprising:
based on the initial relative vector, determining an initial vehicle coordinate of the vehicle; and
after the initial time, moving the vehicle to a subsequent location;
wherein determining the subsequent vehicle coordinate of the vehicle is further based on the initial relative vector, the subsequent relative vector, and the initial vehicle coordinates.

3. The method of claim 1, wherein flagging the initial tag at the initial location at the initial time further comprises physically modifying the initial location.

4. The method of claim 3, wherein physically modifying the initial location includes moving a physical object at the initial location.

5. The method of claim 4, wherein moving a physical object at the initial location includes mechanically drawing a shape in a surface of the initial location via a retractable device of the vehicle.

6. The method of claim 3, wherein physically modifying the initial location includes applying a physical marker to the initial location.

7. The method of claim 6, wherein:
the physical marker emits or reflects energy; and
the vehicle discerns the second relative vector based on the energy.

8. The method of claim 3, wherein physically modifying the initial location includes performing a modification that is impermanent.

9. The method of claim 3, wherein physically modifying the initial location includes performing a modification that is camouflaged.

10. The method of claim 1, wherein flagging the initial tag at the initial location at the initial time further comprises identifying a physical object at the initial location via a sensor.

11. The method of claim 10, wherein the sensor is a passive sensor.

12. The method of claim 1, further comprising:
after the initial time, moving the vehicle to a subsequent location;
while moving the vehicle, tracking an acceleration force measurement by an accelerometer of the vehicle; and
wherein determining the subsequent vehicle coordinate of the vehicle is further based on the subsequent relative vector and the acceleration force measurement.

13. The method of claim 1, wherein the subsequent vehicle coordinate is a relative coordinate; and
further comprising:
determining an initial vehicle coordinate of the vehicle at a preliminary location by coupling with a Global Positioning System, the preliminary vehicle coordinate a geographic coordinate; and
determining a geographic subsequent vehicle coordinate based on the initial relative vector, the subsequent relative vector, and the initial vehicle coordinate.

14. The method of claim 1, wherein the subsequent vehicle coordinate is a relative coordinate; and
further comprising:
discerning, by the vehicle, an ultimate relative vector between a subsequent tag and the vehicle at an ultimate location at an ultimate time;
determining an ultimate vehicle coordinate of the vehicle at the ultimate location by coupling with a Global Positioning System, the ultimate vehicle coordinate a geographic coordinate; and
based on the subsequent relative vector, the ultimate relative vector, and the ultimate vehicle coordinate, determining a geographic subsequent vehicle coordinate of the vehicle.

15. The method of claim 1, further comprising:
flagging, by the vehicle, a reference tag;
discerning, by the vehicle, an initial reference vector between the reference tag and the vehicle at the initial time; and
discerning, by the vehicle, a subsequent reference vector between the reference tag and the vehicle at the subsequent location at the subsequent time;
wherein determining the subsequent vehicle coordinate of the vehicle is further based on the initial relative vector, the subsequent relative vector, the initial reference vector, and the subsequent reference vector.

16. The method of claim 1, further comprising:
receiving a reference coordinate of the initial tag; and
determining a geographic initial vehicle coordinate of the vehicle is based on the initial relative vector and the reference coordinate.

17. The method of claim 1, wherein determining the subsequent vehicle coordinate of the vehicle is further based on the initial relative vector, the subsequent relative vector, a compass reading, and a bearing map.

18. The method of claim 1, wherein:
discerning the initial reference vector at the initial time is by an initial sensor of the vehicle, the initial sensor at an initial height relative to the vehicle at the initial time;
discerning the subsequent reference vector at the subsequent time is by a subsequent sensor of the vehicle, the subsequent sensor at a subsequent height relative to the vehicle; and
the initial height is unequal to the subsequent height.

19. A vehicle controller configured to:
flag an initial tag located at an initial location at an initial time;
discern an initial relative vector between the initial tag and a vehicle at the initial time;
discern a subsequent relative vector between the initial tag and the vehicle at a subsequent location at a subsequent time; and
based on the initial relative vector and the subsequent relative vector, determine a subsequent vehicle coordinate of the vehicle.

20. Non-transitory, computer-readable media for storing instructions executable by one or more processors of a vehicle controller, causing the vehicle controller to perform operations comprising:
flagging an initial tag located at an initial location at an initial time;
discerning an initial relative vector between the initial tag and a vehicle at the initial time;
discerning a subsequent relative vector between the initial tag and the vehicle at a subsequent location at a subsequent time; and
based on the initial relative vector and the subsequent relative vector, determining a subsequent vehicle coordinate of the vehicle.
